(19) United States
(12) Patent Application Publication
(10) Pub. No.: US 2023/0385661 A1
(43) Pub. Date: Nov. 30, 2023

(54) INFERENCE DEVICE, INFERENCE METHOD, AND INFERENCE PROGRAM

(71) Applicant: NIPPON TELEGRAPH AND TELEPHONE CORPORATION, Tokyo (JP)

(72) Inventors: Atsuhiko MAEDA, Tokyo (JP); Kenichi FUKUDA, Tokyo (JP); Yukio KIKUYA, Tokyo (JP); Sun Yeong KIM, Tokyo (JP); Kazuaki OBANA, Tokyo (JP)

(73) Assignee: NIPPON TELEGRAPH AND TELEPHONE CORPORATION, Tokyo (JP)

(21) Appl. No.: 18/034,257

(22) PCT Filed: Oct. 30, 2020
(86) PCT No.: PCT/JP2020/040902

§ 371 Date: Apr. 27, 2023

(51) Int. Cl. G06N 5/04

(52) U.S. Cl. CPC G06N 5/04

(57) ABSTRACT

A comparison unit 68 compares target data to be inferred with a learning data group that is data used for learning of the inference model, and determines that an inference result is uncertain when a comparison result does not satisfy a fixed criterion. A notification unit 70 notifies a user that the inference result is uncertain in addition to the inference result when the inference result is determined to be uncertain.

### TECHNICAL FIELD

The technology of the present disclosure relates to an inference device, an inference method, and an inference program.

### BACKGROUND ART

In recent years, an inference model of event occurrence is created and used by machine learning of a large amount of data in various fields.

### CITATION LIST

### Non Patent Literature

Non Patent Literature 1: “Effectiveness of an optimal operation system for ambulance cars using big data on emergency transport has been confirmed”, Internet <URL:https://www.ntt.co.jp/news2018/1811/181126a.html>

### SUMMARY OF INVENTION

### Technical Problem

In a case of supervised learning, an inference model is created by learning using learning data that is a set of an explanatory variable and an objective variable. At this time, if inference by machine learning is within a range of values taken by an explanatory variable used for learning, an inference result with relatively high reliability can be obtained by so-called interpolation. However, in a case where a situation outside the range of the values of the explanatory variable used for the learning is inferred, so-called extrapolation is used. Thus, inference accuracy is unknown, and reliability of the inference is reduced.

For example, in a case where average daytime temperature is used as the explanatory variable and the number of heat stroke patients occurring in one day is inferred as the objective variable, it is assumed that, as learning data that can be used for learning, there are records in the range of 28 degrees to 31 degrees as daily average temperature records and data of the number of heat strokes occurring in each day. From this learning data, an inference model in which the number of heat stroke patients increases by approximately 100 every time the temperature increases by one degree from 28 degrees can be created. However, it is unclear whether heat stroke patients increase at the same rate when the temperature reaches 33 degrees, 34 degrees, or the like, which are not in the observation records so far. Possibly, heat stroke patients may increase exponentially from such temperatures. However, it is not possible to verify which one is given since there is no record of the number of heat strokes occurring at such temperatures in the past learning data.

The above is a case where the explanatory variable is a continuous value, but when the explanatory variable is a discrete value, a small amount of learning data for each value of the discrete value leads to a decrease in reliability of inference. For example, in a certain region, it is desired to predict the number of traffic accidents occurring in one day from daytime weather on that day. At this time, if past learning data has been sufficiently accumulated for the number of traffic accidents occurring on “sunny,” “cloudy,” and “rainy” days, the number of traffic accidents in those weather conditions can be inferred with sufficient accuracy.

However, a case where weather such as “heavy rain” or “snow” hardly occurs in the region and such a case has occurred only once or twice in the past can be considered. In this case, even if a model for inferring the number of traffic accidents occurring in such weather can be created, reliability of inference in such weather should be low.

In addition, as described above, a user of the machine learning system often does not notice that the explanatory variable of a condition to be inferred is near a maximum value or near a minimum value of a value range of the learning data. In particular, in a case where arrangement of an ambulance is considered on the basis of prediction of occurrence of sick/injured people, there is a case where a paramedic or an operator considers that if a prediction result is uncertain, it should be determined heuristically without following determination of a system using machine learning. This is because the machine learning is a black box from the viewpoint of the paramedic or the operator, and thus it is sometimes desired to make determination in consideration of experience of the paramedic or the operator and the determination of the system. That is, for example, in order for the paramedic or the operator to make a final decision, certainty of a prediction result of the system using the machine learning should be presented to the user, and when the prediction result is uncertain, a reason thereof should also be presented, but there is also a problem in that the prediction result cannot be presented.

The disclosed technology has been made in view of the above points, and an object thereof is to provide an inference device, an inference method, and an inference program capable of notifying a user that an inference result based on an inference model is uncertain.

### Solution to Problem

A first aspect of the present disclosure is an inference device that notifies a user that an inference result based on an inference model is uncertain together with the inference result when the inference result is uncertain, the inference device including: a comparison unit that compares target data to be inferred with a learning data group that is data used for learning of the inference model, and determines that the inference result is uncertain when a comparison result does not satisfy a fixed criterion; and a notification unit that notifies the user that the inference result is uncertain in addition to the inference result when the inference result is determined to be uncertain.

A second aspect of the present disclosure is an inference method in an inference device that notifies a user that an inference result based on an inference model is uncertain together with the inference result when the inference result is uncertain, in which a comparison unit compares target data to be inferred with a learning data group that is data used for learning of the inference model, and determines that the inference result is uncertain when a comparison result does not satisfy a fixed criterion, and a notification unit notifies the user that the inference result is uncertain in addition to the inference result when the inference result is determined to be uncertain.

A third aspect of the present disclosure is an inference program for notifying a user that an inference result based on an inference model is uncertain together with the inference result when the inference result is uncertain, the inference program for causing a computer to: compare target data to be inferred with a learning data group that is data used for learning of the inference model, and determine that the inference result is uncertain when a comparison result does not satisfy a fixed criterion; and notify the user that the inference result is uncertain in addition to the inference result when the inference result is determined to be uncertain.

### Advantageous Effects of Invention

According to the disclosed technology, it is possible to notify the user that the inference result based on the inference model is uncertain.

### BRIEF DESCRIPTION OF DRAWINGS

FIG. 1 is a schematic block diagram of an example of a computer functioning as a learning device and an inference device according to a first embodiment, a second embodiment, and a third embodiment.

FIG. 2 is a block diagram illustrating a functional configuration of a learning device according to the first embodiment, the second embodiment, and the third embodiment.

FIG. 3 is a graph illustrating an example of a distribution of an explanatory variable which is a continuous value of a learning data group.

FIG. 4 is a graph illustrating an example of a distribution of an explanatory variable which is a discrete value of a learning data group.

FIG. 5 is a block diagram illustrating a functional configuration of a learning device according to the first embodiment and the third embodiment.

FIG. 6 is a diagram illustrating an example of a result of comparing an explanatory variable that is a continuous value of target data with the distribution of the explanatory variable that is the continuous value of the learning data group.

FIG. 7 is a diagram illustrating an example of a result of comparing an explanatory variable that is a continuous value of target data with the distribution of the explanatory variable that is the continuous value of the learning data group.

FIG. 8 is a diagram illustrating an example of a result of comparing an explanatory variable that is a discrete value of target data with the distribution of the explanatory variable that is the discrete value of the learning data group.

FIG. 9 is a flowchart illustrating a flow of inference processing of the first embodiment, the second embodiment, and the third embodiment.

FIG. 10 is a block diagram illustrating a functional configuration of an inference device according to the second embodiment.

FIG. 11 is a diagram illustrating an example of a result of comparing a condition variable that is a continuous value of target data with a distribution of a condition variable that is a continuous value of a learning data group.

### DESCRIPTION OF EMBODIMENTS

Hereinafter, examples of embodiments of the disclosed technology will be described with reference to the drawings. In the drawings, the same or equivalent components and portions are denoted by the same reference numerals. In addition, dimensional ratios in the drawings are exaggerated for convenience of description, and may be different from actual ratios.

### First Embodiment

### Configuration of Learning Device According to First Embodiment

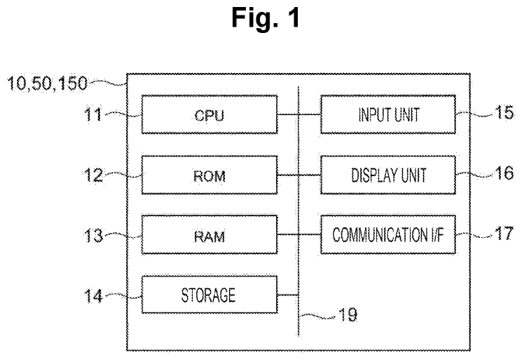

FIG. 1 is a block diagram illustrating a hardware configuration of a learning device 10 according to a first embodiment.

As illustrated in FIG. 1, the learning device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, and executes various programs and controls each unit. That is, the CPU 11 reads the program from the ROM 12 or the storage 14, and executes the program using the RAM 13 as a work region. The CPU 11 performs control of each of the above-described components and various types of operation processing according to a program stored in the ROM 12 or the storage 14. In the present embodiment, a learning program for learning an inference model is stored in the ROM 12 or the storage 14. The learning program may be one program or a program group including a plurality of programs or modules.

The ROM 12 stores various programs and various types of data. The RAM 13 temporarily stores programs or data as a work region. The storage 14 includes a hard disk drive (HDD) or a solid state drive (SSD), and stores various programs including an operating system and various types of data.

The input unit 15 includes a pointing device such as a mouse and a keyboard, and is used to perform various inputs.

The input unit 15 receives a learning data group as an input. Specifically, the input unit 15 receives a learning data group including a plurality of pieces of learning data that is a set of an explanatory variable including a continuous value and a discrete value and an objective variable. For example, a set of an explanatory variable including a daytime average temperature and weather (sunny, cloudy, rain, heavy rain, others) in the past three years and an objective variable that is the number of occurrences of sick/injured people in one day is set as learning data. Here, the average temperature is an example of the continuous value, and the weather is an example of the discrete value.

The display unit 16 is, for example, a liquid crystal display, and displays various types of information. The display unit 16 may function as the input unit 15 by adopting a touch panel system.

The communication interface 17 is an interface for communicating with other devices, and for example, standards such as Ethernet (registered trademark), FDDI, and Wi-Fi (registered trademark) are used.

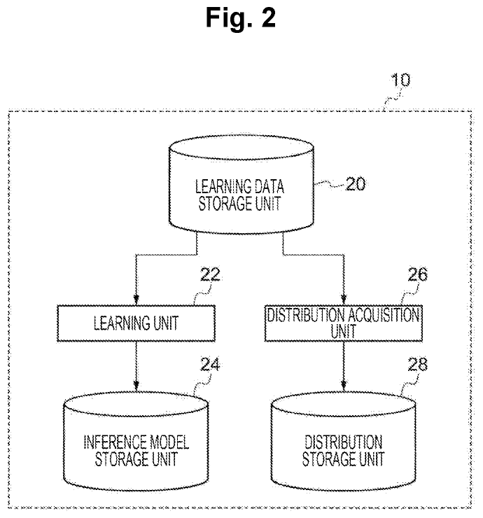

Next, a functional configuration of the learning device 10 will be described. FIG. 2 is a block diagram illustrating an example of the functional configuration of the learning device 10.

The learning device 10 functionally includes a learning data storage unit 20, a learning unit 22, an inference model storage unit 24, a distribution acquisition unit 26, and a distribution storage unit 28, as illustrated in FIG. 2.

The learning data storage unit 20 stores the input learning data group.

The learning unit 22 learns an inference model that infers an objective variable from an explanatory variable on the basis of the learning data group.

For example, the inference model is a multiple regression model as follows.

The number of sick/injured people=coefficient 1*temperature+coefficient 2*sunny flag+coefficient 3*cloudy flag+coefficient 4*rain flag+coefficient 5*heavy rain flag+intercept
wherein the sunny flag is set to 1 when the weather is sunny, and is set to 0 at other times. The same applies to the cloudy flag, the rain flag, and the like. The coefficients 1 to 5 and the intercept are parameters obtained by learning by the learning unit 22. The following is an example of an inference model in which coefficients and intercepts are obtained.

The number of sick/injured people=10*temperature+10*sunny flag+10*cloudy flag+20*rain flag+50*heavy rain flag+20

The inference model storage unit 24 stores a learned inference model.

The distribution acquisition unit 26 acquires a distribution of an explanatory variable on the basis of the learning data group.

Here, the explanatory variable can include two types of data. One is a continuous value, and another is a discrete value.

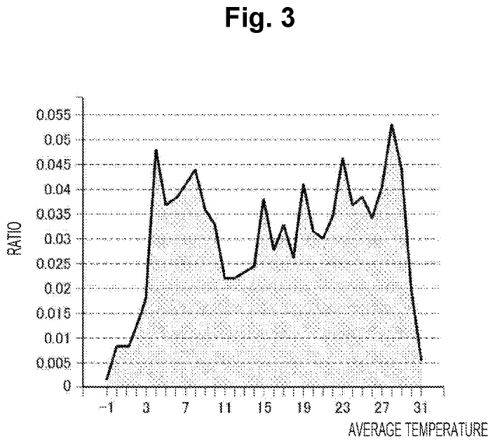

FIG. 3 illustrates an example of a temperature distribution which is a continuous value in the learning data group. This distribution represents, for each temperature, a ratio of learning data of the temperature in the learning data group.

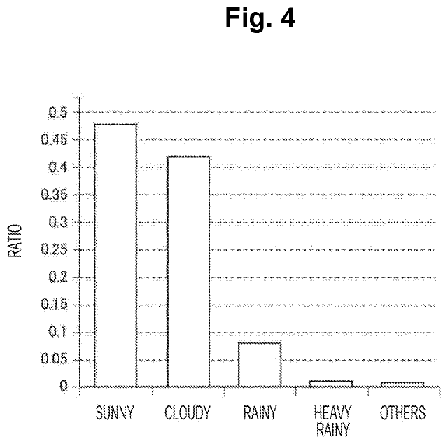

In addition, FIG. 4 illustrates an example of a weather distribution which is a discrete value in the learning data group. This distribution represents, for each weather, a ratio of learning data of the weather in the learning data group.

The distribution storage unit 28 stores the distribution of the explanatory variable obtained by the distribution acquisition unit 26.

### Configuration of Inference Device According to First Embodiment

FIG. 1 is a block diagram illustrating a hardware configuration of an inference device 50 according to the first embodiment.

As illustrated in FIG. 1, the inference device 50 has a configuration similar to that of the learning device 10, and an inference program for performing inference by an inference model is stored in the ROM 12 or the storage 14.

The input unit 15 receives target data to be inferred as an input. Specifically, the input unit 15 receives an explanatory variable including a continuous value and a discrete value as the target data. For example, an explanatory variable including a daytime average temperature and weather (sunny, cloudy, rain, heavy rain, others) on an inference target day is set as target data.

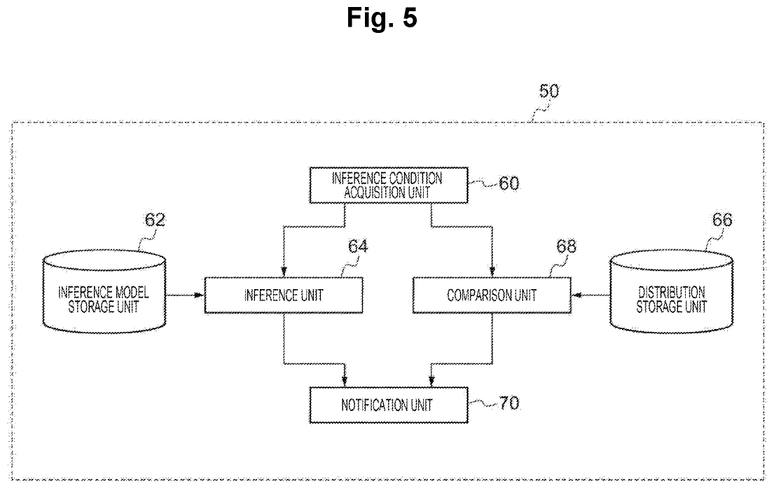

Next, a functional configuration of the inference device 50 will be described. FIG. 5 is a block diagram illustrating an example of the functional configuration of the inference device 50.

The inference device 50 functionally includes an inference condition acquisition unit 60, an inference model storage unit 62, an inference unit 64, a distribution storage unit 66, a comparison unit 68, and a notification unit 70, as illustrated in FIG. 5.

The inference condition acquisition unit 60 acquires an explanatory variable of the input target data.

The inference model storage unit 62 stores an inference model learned by the learning device 10.

The inference unit 64 infers an objective variable on the basis of the inference model stored in the inference model storage unit 62 and the acquired explanatory variable of the target data. For example, the number of sick/injured people occurring on the inference target day is inferred on the basis of the inference model, and the daytime average temperature and the weather on the inference target day.

Some examples are given below.

When the temperature is 20 degrees and the weather is sunny, the following is obtained.

The number of sick/injured people=10*20+10*1+10*0+20*0+50*0+20=230

When the temperature is 32 degrees and the weather is sunny, the following is obtained.

The number of sick/injured people=10*32+10*1+10*0+20*0+50*0+20=330

When the temperature is 18 degrees and the weather is heavy rain, it is as follows.

The number of sick/injured people=10*18+10*0+10*0+20*0+50*1+20=250

The inferred number of sick/injured people is output to a user by the notification unit 70, and the user can confirm an inference result.

Here, it is assumed that there is only learning data in which the temperature is from −1 degrees to 31 degrees in the learning data group. In addition, it is assumed that there is only 1% of heavy rain records in the learning data group. In such a case, in a case where the temperature when it is desired to predict the number of sick/injured people is 32 degrees or the weather is heavy rain, reliability of the inference result is questionable.

In order to make the user aware of these, the inference device 50 also operates the comparison unit 68 using the distribution storage unit 66 in parallel with operation of the inference unit 64, and compares a distribution of an explanatory variable of the learning data group with the explanatory variable of the target data.

Specifically, the distribution storage unit 66 stores the distribution of the explanatory variable of the learning data group, similarly to the distribution storage unit 28. For example, the distribution storage unit 66 stores a temperature distribution for the learning data group as illustrated in FIG. 3 and a weather distribution for the learning data group as illustrated in FIG. 4.

The comparison unit 68 compares the explanatory variable of the target data to be inferred with the distribution of the explanatory variable of the learning data group, and determines that an inference result by the inference unit 64 is uncertain when a comparison result does not satisfy a fixed criterion.

Specifically, in a case where an explanatory variable being a continuous value is compared with the distribution of the explanatory variable of the learning data group, a fixed criterion is that the explanatory variable being the continuous value of the target data is equal to or less than a reference value corresponding to a maximum value of the explanatory variable being the continuous value of the learning data group and is equal to or more than a reference value corresponding to a minimum value of the explanatory variable being the continuous value of the learning data group. The comparison unit 68 determines whether the comparison result does not satisfy the fixed criterion.

For example, a value at which a data ratio is 5% near the maximum value of the explanatory variable, which is the continuous value of the learning data group, is set as a reference value, and when the explanatory variable is larger than the reference value, it is determined that the inference result by the inference unit 64 is uncertain. In addition, a value at which a data ratio is 5% near the minimum value of the explanatory variable, which is the continuous value of the learning data group, is set as a reference value, and when the explanatory variable is smaller than the reference value, it is determined that the inference result by the inference unit 64 is uncertain.

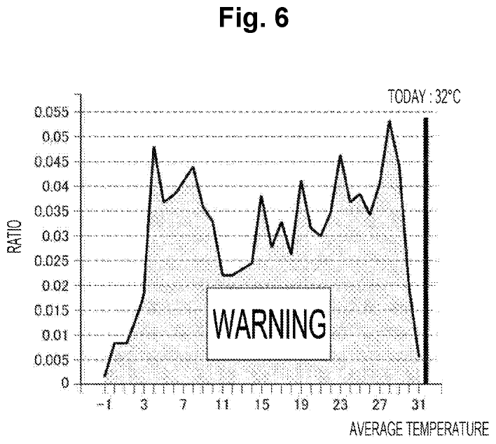

FIG. 6 illustrates a result of comparing a temperature of 32 degrees with the temperature distribution of the learning data group. The temperature of 32 degrees is higher than 31 degrees, which is a temperature at which the data ratio is 5% near the maximum value of the temperature of the learning data group. Therefore, the comparison unit 68 determines that the inference result by the inference unit 64 is uncertain.

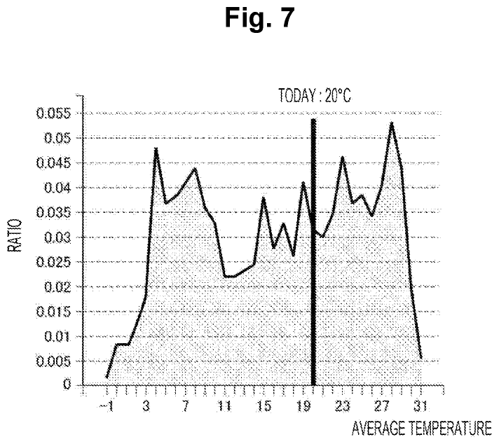

FIG. 7 illustrates a result of comparing a temperature of 20 degrees with the temperature distribution of the learning data group. The temperature of 20 degrees is equal to or less than 31 degrees, which is the temperature at which the data rate is 5% near the maximum value of the temperature of the learning data group, and is equal to or more than 0 degrees, which is a temperature at which the data ratio is 5% near the minimum value of the temperature of the learning data group. Therefore, the comparison unit 68 determines that the inference result by the inference unit 64 is not uncertain.

In addition, in a case where an explanatory variable that is a discrete value is compared with the distribution of the explanatory variable of the learning data group, a fixed criterion is that the number of data in which the explanatory variable that is the discrete value of the learning data group coincides with the explanatory variable that is the discrete value of the target data is greater than or equal to a reference number. The comparison unit 68 determines whether the comparison result does not satisfy the fixed criterion.

For example, a reference value is set to a data ratio of 5%, and when a ratio of the number of data in which the explanatory variable that is the discrete value of the learning data group coincides with the explanatory variable that is the discrete value of the target data is less than the reference value, it is determined that the inference result by the inference unit 64 is uncertain. On the other hand, when the ratio of the number of data in which the explanatory variable that is the discrete value of the learning data group coincides with the explanatory variable that is the discrete value of the target data is equal to or more than the reference value, it is determined that the inference result by the inference unit 64 is not uncertain.

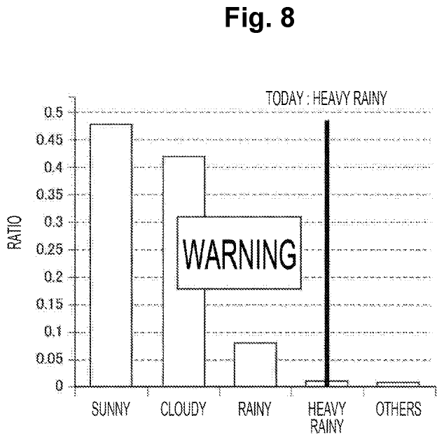

FIG. 8 illustrates a result of comparison with the weather distribution of the learning data group in a case where the weather is “heavy rain”. A data ratio of the learning data of which the weather is “heavy rain” is less than 5%. Therefore, the comparison unit 68 determines that the inference result by the inference unit 64 is uncertain. On the other hand, in a case where the weather is “sunny,” “cloudy,” or “rainy,” since the data ratio is 5% or more in all cases, the comparison unit 68 determines that the inference result by the inference unit 64 is not uncertain.

Furthermore, in the present embodiment, the comparison unit 68 compares, for each of the explanatory variables, the explanatory variable of the target data with the distribution of the explanatory variable in the learning data group. When a comparison result of at least one explanatory variable does not satisfy a fixed criterion, the comparison unit 68 determines that the inference result by the inference unit 64 is uncertain. On the other hand, when the comparison results of all the explanatory variables satisfy the fixed criterion, the comparison unit 68 determines that the inference result by the inference unit 64 is not uncertain.

In a case where it is determined that the inference result by the inference unit 64 is uncertain, the notification unit 70 notifies the user, by the display unit 16, that the inference result is uncertain in addition to the inference result by the inference unit 64. For example, as illustrated in FIGS. 6 and 8, a warning message notifying that the inference result is uncertain is displayed by the display unit 16. On the other hand, in a case where it is determined that the inference result by the inference unit 64 is not uncertain, the notification unit 70 outputs only the inference result by the inference unit 64 to the user by the display unit 16.

### Actions of Learning Device According to First Embodiment

Next, actions of the learning device 10 according to the first embodiment will be described.

Learning processing is performed by the CPU 11 reading a learning program from the ROM 12 or the storage 14, developing the learning program in the RAM 13, and executing the learning program. Furthermore, a learning data group is input to the learning device 10. In the learning processing of the learning device 10, the learning unit 22 learns an inference model that infers an objective variable from an explanatory variable on the basis of the learning data group, and stores the learned inference model in the inference model storage unit 24. Then, the distribution acquisition unit 26 acquires a distribution of the explanatory variable on the basis of the learning data group and stores the distribution in the distribution storage unit 28.

### Actions of Inference Device According to First Embodiment

Next, actions of the inference device 50 according to the first embodiment will be described.

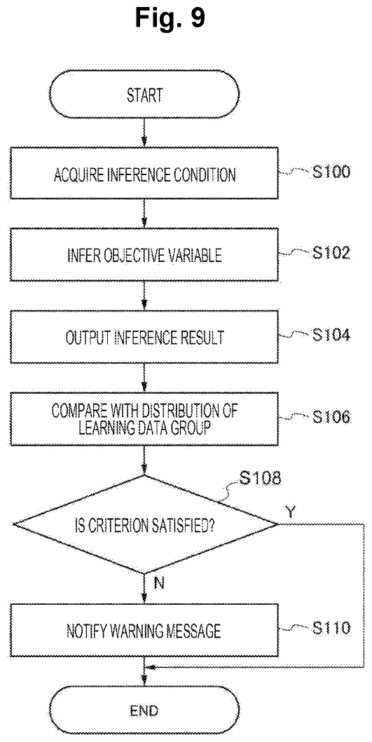

FIG. 9 is a flowchart illustrating a flow of inference processing by the inference device 50. The inference processing is performed by the CPU 11 reading an inference program from the ROM 12 or the storage 14, developing the inference program in the RAM 13, and executing the inference program. Furthermore, target data to be inferred is input to the inference device 50.

In step S100, the CPU 11, as the inference condition acquisition unit 60, acquires an explanatory variable of the input target data.

In step S102, the CPU 11, as the inference unit 64, infers an objective variable on the basis of an inference model stored in the inference model storage unit 62 and the acquired explanatory variable of the target data.

In step S104, the CPU 11, as the notification unit 70, causes the display unit 16 to display an inference result by the inference unit 64.

In step S106, the CPU 11, as the comparison unit 68, compares the explanatory variable of the target data to be inferred with a distribution of an explanatory variable of a learning data group.

In step S108, the CPU 11 determines, as the comparison unit 68, whether or not a comparison result satisfies a fixed criterion. When the comparison result does not satisfy the fixed criterion, it is determined that the inference result by the inference unit 64 is uncertain, and the processing proceeds to step S110. On the other hand, when the comparison result satisfies the fixed criterion, it is determined that the inference result by the inference unit 64 is not uncertain, and the inference processing is terminated.

In step S110, the CPU 11, as the notification unit causes the display unit 16 to display a warning message notifying that the inference result output in step S104 is uncertain, and ends the inference processing.

As described above, the inference device according to the first embodiment can notify the user that the inference result based on the inference model is uncertain by comparing the target data to be inferred with the learning data group used for learning of the inference model and by determining whether the comparison result does not satisfy the fixed criterion. In addition, when an inference condition that lowers reliability of the inference model is encountered, the user of the inference model can notice the situation.

### Second Embodiment

### Configuration of Learning Device According to Second Embodiment

Since a learning device of a second embodiment is similar to the learning device 10 of the first embodiment, the same reference numerals are given and description thereof is omitted.

### Configuration of Inference Device According to Second Embodiment

Next, an inference device according to the second embodiment will be described. Note that parts having configurations similar to those of the first embodiment are denoted by the same reference numerals, and description thereof is omitted.

A hardware configuration of an inference device 150 of the second embodiment is similar to the hardware configuration of the inference device 50 illustrated in FIG. 1.

The input unit 15 receives target data to be inferred as an input. Specifically, the input unit 15 receives an explanatory variable including a continuous value and a discrete value as the target data. For example, an explanatory variable including a daytime average temperature and weather (sunny, cloudy, rain, heavy rain, others) on an inference target day is set as target data.

Furthermore, the input unit 15 receives, as an input, future target data later than the target data to be inferred. Specifically, a future explanatory variable later than an explanatory variable on the date and time to be inferred is received as an input. For example, in a case where the date and time to be inferred is tomorrow, an explanatory variable including a daytime average temperature and weather for six days from the day after tomorrow onward for one week is received as an input. Note that the number of days may be other than six days, and for example, may be any one of one day to five days, or may be seven days or more.

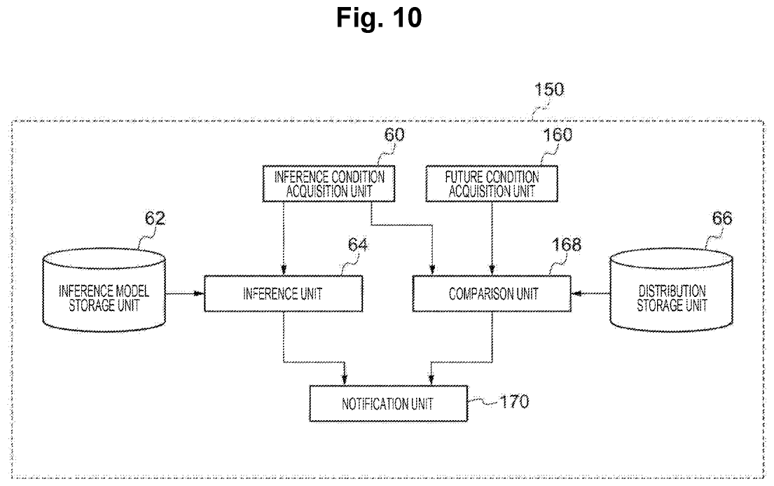

Next, a functional configuration of the inference device 150 will be described. FIG. 10 is a block diagram illustrating an example of the functional configuration of the inference device 150.

As illustrated in FIG. 10, the inference device 150 functionally includes the inference condition acquisition unit 60, the inference model storage unit 62, the inference unit 64, the distribution storage unit 66, a future condition acquisition unit 160, a comparison unit 168, and a notification unit 170.

The future condition acquisition unit 160 acquires an explanatory variable of the input future target data later than the target data to be inferred.

Similarly to the comparison unit 68, the comparison unit 168 compares an explanatory variable of the target data to be inferred with a distribution of an explanatory variable of a learning data group, and determines that an inference result by the inference unit 64 is uncertain when a comparison result does not satisfy a fixed criterion.

Furthermore, the comparison unit 168 compares, for each of the future target data, the explanatory variable of the future target data with the distribution of the explanatory variable of the learning data group, and determines that a future inference result by the inference unit 64 is uncertain in a case where a comparison result does not satisfy a fixed criterion. For example, regarding a daily average temperature of the future target data, a value at which a data ratio is 5% near a maximum value of an average temperature of the learning data group is set as a reference value, and if the explanatory variable is larger than the reference value, it is determined that the future inference result by the inference unit 64 is uncertain. In addition, regarding the daily average temperature of the future target data, a value at which a data ratio is 5% near a minimum value of the average temperature of the learning data group is set as a reference value, and if the explanatory variable is smaller than the reference value, it is determined that the future inference result by the inference unit 64 is uncertain.

Furthermore, regarding daily weather of the future target data, if a ratio of the number of data matching the weather of the learning data group is less than a reference value, it is determined that a future inference result by the inference unit 64 is uncertain. Furthermore, regarding the daily weather of the future target data, if the ratio of the number of data matching the weather of the learning data group is equal to or greater than the reference value, it is determined that the future inference result by the inference unit 64 is not uncertain.

Furthermore, in the present embodiment, the comparison unit 168 compares, for each of the explanatory variables, the explanatory variable of the target data with the distribution of the explanatory variable in the learning data group. When a comparison result of at least one explanatory variable does not satisfy a fixed criterion, the comparison unit 168 determines that the inference result by the inference unit 64 is uncertain. On the other hand, when the comparison results of all the explanatory variables satisfy the fixed criterion, the comparison unit 168 determines that the inference result by the inference unit 64 is not uncertain.

Furthermore, in the present embodiment, the comparison unit 168 compares, for each of the explanatory variables, the explanatory variable of the future target data with the distribution of the explanatory variable in the learning data group. When a comparison result of at least one explanatory variable does not satisfy a fixed criterion, the comparison unit 168 determines that the future inference result by the inference unit 64 is uncertain. On the other hand, when the comparison results of all the explanatory variables satisfy the fixed certain criterion, the comparison unit 168 determines that the future inference result by the inference unit 64 is not uncertain.

In a case where it is determined that the inference result by the inference unit 64 is uncertain, the notification unit 170 notifies a user, by the display unit 16, that the inference result is uncertain in addition to the inference result by the inference unit 64. On the other hand, in a case where it is determined that the inference result by the inference unit 64 is not uncertain, the notification unit 170 outputs only the inference result by the inference unit 64 to the user by the display unit 16.

Furthermore, in a case where it is determined that the future inference result by the inference unit 64 is uncertain, the notification unit 170 notifies the user that the future inference result is uncertain by the display unit 16.

Note that other configurations and actions of the learning device 10 and the inference device 150 according to the second embodiment are similar to those of the first embodiment, and thus, description thereof is omitted.

As described above, the inference device according to the second embodiment compares the future explanatory variable later than the target data to be inferred with the distribution of the explanatory variable of the learning data group used for learning of the inference model, and determines whether the comparison result does not satisfy the fixed criterion, thereby notifying the user that the future inference result based on the inference model is uncertain.

In addition, temperature forecast information can be generally obtained not only tomorrow but also about one week after tomorrow. In such a case, the user can quickly notice a situation in which reliability of the inference result is lowered in the near future.

### Third Embodiment

### Configuration of Third Embodiment

In the first and second embodiments described above, the case where the explanatory variable of the target data is compared with the distribution of the explanatory variable of the learning data group has been described as an example. However, in the present embodiment, a distribution of a value of a variable different from the explanatory variable included in the learning data is compared with a value of the variable of the target data.

For example, in the above example of inferring the number of sick/injured people, assuming that a daytime population of a target region is about two million people and its value does not usually change, and the daytime population of the target region when the learning data is recorded is actually about two million people in almost all cases, it is sufficiently possible that population is not added as an explanatory variable of an inference model. In addition, the above inference model is an inference model on the premise that the daytime population is around two million people.

However, a possibility that the population significantly decreases or increases in rare cases due to a historically large disaster, an event, or the like is considered. In that case, it is desired to be able to warn that reliability of an inference result of the inference model will decrease. Therefore, in the present embodiment, a population distribution at a normal time in the target region is also stored, and a daytime population in a target region on an inference target day, which is not an explanatory variable of the inference model, can also be acquired. Then, the daytime population in the target region on the inference target day is compared with the normal population distribution, and if the daytime population in the target region on the inference target day is close to a maximum value or a minimum value of the normal population distribution, a warning is issued.

### Configuration of Learning Device According to Third Embodiment

Since a learning device of the third embodiment is similar to the learning device 10 of the first embodiment, the same reference numerals are given and description thereof is omitted.

The input unit 15 receives a learning data group as an input. Specifically, the input unit 15 receives a learning data group including a plurality of pieces of learning data that is a set of an explanatory variable including a continuous value and a discrete value and an objective variable. Here, the learning data includes a condition variable that is a variable different from the explanatory variable and serves as an inference condition. For example, a daytime population in a target region, which is different from explanatory variables (daytime average temperature and weather), is included in the learning data as the condition variable. Note that as a method of acquiring the population of the target region, a method of determining a population for each region using a base station of a mobile phone or a GPS function may be used.

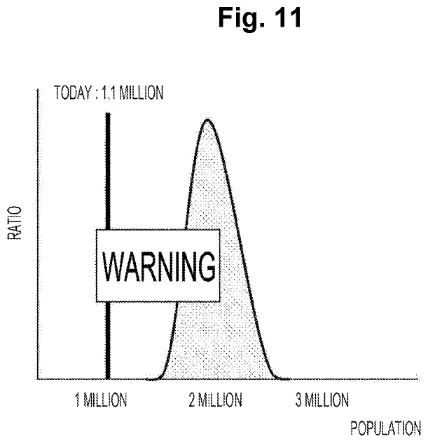

The distribution acquisition unit 26 acquires a distribution of the condition variables based on the learning data group. For example, the distribution acquisition unit 26 acquires a distribution of daytime population which is data of a continuous value as illustrated in FIG. 11. This distribution represents a ratio of the learning data of the population in the learning data group for each population.

The distribution storage unit 28 stores the distribution of the condition variable obtained by the distribution acquisition unit 26.

### Configuration of Inference Device According to Third Embodiment

Since the inference device of the third embodiment is similar to the inference device 50 of the first embodiment, the same reference numerals are given and description thereof is omitted.

The input unit 15 receives target data to be inferred as an input. Specifically, the input unit 15 receives an explanatory variable including a continuous value and a discrete value as the target data. In addition, the target data includes a condition variable that is a variable different from the explanatory variable and serves as an inference condition. For example, a daytime population in a target region, which is different from the explanatory variable (daytime average temperature and weather), is included in the target data as the condition variable.

The inference condition acquisition unit 60 acquires the explanatory variable and the condition variable of the input target data.

The inference unit 64 infers an objective variable on the basis of an inference model stored in the inference model storage unit 62 and the acquired explanatory variable of the target data.

Similarly to the distribution storage unit 28, the distribution storage unit 66 stores a distribution of the condition variable of the learning data group.

The comparison unit 68 compares the condition variable of the target data to be inferred with the distribution of the condition variable of the learning data group, and determines that an inference result by the inference unit 64 is uncertain when a comparison result does not satisfy a fixed criterion.

Specifically, when the condition variable that is the continuous value is compared with the distribution of the condition variable of the learning data group, the fixed criterion is that the continuous value of the target data is less than or equal to a reference value corresponding to a maximum value of the continuous value of the learning data group and greater than or equal to a reference value corresponding to a minimum value of the continuous value of the learning data group. The comparison unit 68 determines whether the comparison result does not satisfy the fixed criterion.

For example, a value at which a data ratio is 5% near the maximum value of the continuous value of the learning data group is set as a reference value, and when the condition variable is larger than the reference value, it is determined that the inference result by the inference unit 64 is uncertain. In addition, a value at which a data ratio is 5% near the minimum value of the continuous value of the learning data group is set as a reference value, and when the condition variable is smaller than the reference value, it is determined that the inference result by the inference unit 64 is uncertain.

FIG. 11 illustrates a result of comparing a daytime population of 1.1 million people with a population distribution in a normal time of the learning data group. The population of 1.1 million people is lower than a population having a data ratio of 5% near a minimum value of the normal population of the learning data group. Therefore, the comparison unit 68 determines that the inference result by the inference unit 64 is uncertain.

In addition, in a case where a condition variable that is a discrete value is compared with the distribution of the condition variable of the learning data group, a fixed criterion is that the number of data in which the condition variable that is the discrete value of the learning data group coincides with a condition variable that is a discrete value of a target data is greater than or equal to a reference number. The comparison unit 68 determines whether the comparison result does not satisfy the fixed criterion.

Note that, also for the explanatory variable, the comparison unit 68 may compare the explanatory variable of the target data with the distribution of the explanatory variable in the learning data group. In this case, when at least one of the comparison result of the condition variable and the comparison result of the explanatory variable does not satisfy a fixed criterion, the comparison unit 68 determines that the inference result by the inference unit 64 is uncertain. On the other hand, when both the comparison result of the condition variable and the comparison result of the explanatory variable satisfy the fixed criterion, the comparison unit 68 determines that the inference result by the inference unit 64 is not uncertain.

In a case where it is determined that the inference result by the inference unit 64 is uncertain, the notification unit 70 notifies a user, by the display unit 16, that the inference result is uncertain in addition to the inference result by the inference unit 64. For example, as illustrated in FIG. 11, a warning message notifying that the inference result is uncertain is displayed by the display unit 16.

Note that other configurations and actions of the learning device 10 and the inference device 50 according to the third embodiment are similar to those of the first embodiment, and thus, description thereof is omitted.

As described above, the inference device according to the third embodiment can notify the user that the inference result based on the inference model is uncertain by comparing the condition variable different from the explanatory variable of the target data to be inferred with the distribution of the condition variable of the learning data group used for learning of the inference model and by determining whether the comparison result does not satisfy the fixed criterion.

Note that the present invention is not limited to the configurations and actions of the devices according to the above-described embodiments, and various modifications and applications can be made without departing from the gist of the present invention.

For example, various processing, which is performed by the CPU reading software (program) in the above embodiments, may be performed by various processors other than the CPU. Examples of the processor in this case include a programmable logic device (PLD) in which a circuit configuration can be changed after manufacturing such as a field-programmable gate array (FPGA), and a dedicated electric circuit that is a processor having a circuit configuration exclusively designed for performing specific processing such as an application specific integrated circuit (ASIC). In addition, the inference processing may be performed by one of these various processors, or may be performed by a combination of two or more processors of the same type or different types (for example, a plurality of FPGAs, a combination of a CPU and an FPGA, and the like). In addition, the hardware structure of these various processors is, more specifically, an electric circuit in which circuit elements such as semiconductor elements are combined.

In each of the above embodiments, the aspect in which the inference program is stored (installed) in advance in the storage 14 has been described, but this is not restrictive. The program may be provided in a form stored in a non-transitory storage medium such as a compact disk read only memory (CD-ROM), a digital versatile disk read only memory (DVD-ROM), and a universal serial bus (USB) memory. The program may be downloaded from an external device via a network.

In each of the above embodiments, a case where the number of occurrences of the sick/injured people is inferred from the weather, the temperature, or the like has been described as an example, but the present invention is not limited thereto. The explanatory variable may be multidimensional data other than the weather and the temperature, and the objective variable may be data other than the number of occurrences of the sick/injured people. In addition, a case where the explanatory variable includes both the continuous value and the discrete value has been described as an example, but the present invention is not limited thereto. The explanatory variable may include only a continuous value or only a discrete value.

In addition, the technology of comparing the condition variable serving as the inference condition with the distribution of the learning data group described in the third embodiment may be applied to the second embodiment, and the future condition variable may be compared with the distribution of the condition variable in the learning data group.

In addition, a case where the learning device and the inference device are configured as separate devices has been described as an example, but the present invention is not limited thereto. The learning device and the inference device may be configured as one device.

With regard to the above embodiments, the following supplementary notes are further disclosed.

(Supplementary Note 1)

An inference device that notifies a user that an inference result based on an inference model is uncertain together with the inference result when the inference result is uncertain, the inference device including:
a memory; and
at least one processor connected to the memory,
in which the processor
compares target data to be inferred with a learning data group that is data used for learning of the inference model, and determines that the inference result is uncertain when a comparison result does not satisfy a fixed criterion, and
notifies the user that the inference result is uncertain in addition to the inference result when the inference result is determined to be uncertain.

(Supplementary Note 2)

A non-transitory storage medium storing a program that can be executed by a computer so as to execute inference processing of notifying a user that an inference result based on an inference model is uncertain, together with the inference result, when the inference result is uncertain, the inference processing including:
comparing target data to be inferred with a learning data group that is data used for learning of the inference model, and determining that the inference result is uncertain when a comparison result does not satisfy a fixed criterion; and
notifying the user that the inference result is uncertain in addition to the inference result when the inference result is determined to be uncertain.

### REFERENCE SIGNS LIST

10 Learning device
15 Input unit
16 Display unit
20 Learning data storage unit
22 Learning unit
24 Inference model storage unit
26 Distribution acquisition unit
28 Distribution storage unit
50, 150 Inference Device
60 Inference condition acquisition unit
62 Inference model storage unit
64 Inference unit
66 Distribution storage unit
68, 168 Comparison unit
70, 170 Notification unit
150 Inference Device
160 Future condition acquisition unit

1. An inference device comprising a processor configured to execute operations comprising:
comparing target data to be inferred with a learning data group, wherein the target data represents that is data used for learning of the inference model;
determining that the inference result is uncertain when a comparison result does not satisfy a fixed criterion; and
notifying the user that the inference result is uncertain in addition to the inference result when the inference result is determined to be uncertain.

2. The inference device according to claim 1, wherein
the data includes a continuous value, and
the fixed criterion includes a continuous value of the target data being less than or equal to a reference value corresponding to a maximum value of a continuous value of the learning data group and being greater than or equal to a reference value corresponding to a minimum value of the continuous value of the learning data group.

3. The inference device according to claim 1, wherein
the data includes a discrete value, and
the fixed criterion includes a number of data in which a discrete value of the learning data group matches a discrete value of the target data is equal to or larger than a reference number.

4. The inference device according to claim 1, wherein
the inference model is a model that infers an objective variable from an explanatory variable, and the processor further configured to execute operations comprising:
comparing a condition variable included in the target data and different from the explanatory variable with the condition variable included in each of the learning data groups; and
determining that the inference result is uncertain when a comparison result does not satisfy a fixed criterion.

5. The inference device according to claim 1, the processor further configured to execute operations comprising:
comparing the target data in a future later than the target data to be inferred with the learning data group;
determining that a future inference result is uncertain when a comparison result does not satisfy the fixed criterion; and
notifying the user that the future inference result is uncertain when the future inference result is determined to be uncertain.

6. A computer implemented method for inferencing, comprising:
comparing target data to be inferred with a learning data group, wherein the target data represents data used for learning of the inference model;
determining that the inference result is uncertain when a comparison result does not satisfy a fixed criterion; and
notifying the user that the inference result is uncertain in addition to the inference result when the inference result is determined to be uncertain.

7. A computer-readable non-transitory recording medium storing computer-executable program instructions that when executed by a processor cause
a computer system to execute operations comprising:
comparing target data to be inferred with a learning data group, wherein the target data represents data used for learning of the inference model;
determining that the inference result is uncertain when a comparison result does not satisfy a fixed criterion; and
notifying the user that the inference result is uncertain in addition to the inference result when the inference result is determined to be uncertain.

8. The inference device according to claim 2, wherein
the inference model is a model that infers an objective variable from an explanatory variable, and the processor further configured to execute operations comprising:
comparing a condition variable included in the target data and different from the explanatory variable with the condition variable included in each of the learning data groups; and
determining that the inference result is uncertain when a comparison result does not satisfy a fixed criterion.

9. The inference device according to claim 2, the processor further configured to execute operations comprising:
comparing the target data in a future later than the target data to be inferred with the learning data group;
determining that a future inference result is uncertain when a comparison result does not satisfy the fixed criterion; and
notifying the user that the future inference result is uncertain when the future inference result is determined to be uncertain.

10. The computer implemented method according to claim 6, wherein
the data includes a continuous value, and
the fixed criterion includes a continuous value of the target data being less than or equal to a reference value corresponding to a maximum value of a continuous value of the learning data group and being greater than or equal to a reference value corresponding to a minimum value of the continuous value of the learning data group.

11. The computer implemented method according to claim 6, wherein
the data includes a discrete value, and
the fixed criterion includes a number of data in which a discrete value of the learning data group matches a discrete value of the target data is equal to or larger than a reference number.

12. The computer implemented method according to claim 6, wherein
the inference model is a model that infers an objective variable from an explanatory variable, and the method further comprising:
comparing condition variable included in the target data and different from the explanatory variable with the condition variable included in each of the learning data groups; and
determining that the inference result is uncertain when a comparison result does not satisfy a fixed criterion.

13. The computer implemented method according to claim 6, the method further comprising:
comparing the target data in a future later than the target data to be inferred with the learning data group;
determining that a future inference result is uncertain when a comparison result does not satisfy the fixed criterion; and
notifying the user that the future inference result is uncertain when the future inference result is determined to be uncertain.

14. The computer implemented method according to claim 10, wherein
the inference model is a model that infers an objective variable from an explanatory variable, and the method further comprising:
comparing condition variable included in the target data and different from the explanatory variable with the condition variable included in each of the learning data groups; and
determining that the inference result is uncertain when a comparison result does not satisfy a fixed criterion.

15. The computer-readable non-transitory recording medium according to claim 7, wherein
the data includes a continuous value, and
the fixed criterion includes a continuous value of the target data being less than or equal to a reference value corresponding to a maximum value of a continuous value of the learning data group and being greater than or equal to a reference value corresponding to a minimum value of the continuous value of the learning data group.

16. The computer-readable non-transitory recording medium according to claim 7, wherein
the data includes a discrete value, and
the fixed criterion includes a number of data in which a discrete value of the learning data group matches a discrete value of the target data is equal to or larger than a reference number.

17. The computer-readable non-transitory recording medium according to claim 7, wherein the inference model is a model that infers an objective variable from an explanatory variable, and
the computer-executable program instructions when executed further causing the computer system to execute operations comprising:
comparing condition variable included in the target data and different from the explanatory variable with the condition variable included in each of the learning data groups; and
determining that the inference result is uncertain when a comparison result does not satisfy a fixed criterion.

18. The computer-readable non-transitory recording medium according to claim 7, the computer-executable program instructions when executed further causing the computer system to execute operations comprising:
comparing the target data in a future later than the target data to be inferred with the learning data group;
determining that a future inference result is uncertain when a comparison result does not satisfy the fixed criterion; and
notifying the user that the future inference result is uncertain when the future inference result is determined to be uncertain.

19. The computer-readable non-transitory recording medium according to claim 7, wherein the inference model is a model that infers an objective variable from an explanatory variable, and
the computer-executable program instructions when executed further causing the computer system to execute operations comprising:
comparing condition variable included in the target data and different from the explanatory variable with the condition variable included in each of the learning data groups; and
determining that the inference result is uncertain when a comparison result does not satisfy a fixed criterion.

20. The computer-readable non-transitory recording medium according to claim 15, wherein the inference model is a model that infers an objective variable from an explanatory variable, and
the computer-executable program instructions when executed further causing the computer system to execute operations comprising:
comparing condition variable included in the target data and different from the explanatory variable with the condition variable included in each of the learning data groups; and
determining that the inference result is uncertain when a comparison result does not satisfy a fixed criterion.
